(19) United States
(12) Patent Application Publication
(10) Pub. No.: US 2026/0019027 A1
(43) Pub. Date: Jan. 15, 2026

(54) COUPLING BRIDGE BEARING HOUSING FOR SOLAR TRACKER

(71) Applicant: Nextracker LLC, Fremont, CA (US)

(72) Inventors: Abhimanyu Anil Sable, Hyderabad (IN); Ricardo Delgado-Nanez, San Jose, CA (US)

(21) Appl. No.: 19/258,654

(22) Filed: Jul. 2, 2025

Related U.S. Application Data
(60) Provisional application No. 63/671,515, filed on Jul. 15, 2024.

(51) Int. Cl. H02S 20/32; F16C 35/02

(52) U.S. Cl. CPC H02S 20/32; F16C 35/02

(57) ABSTRACT

A solar tracker bearing housing includes a closed hoop and a pier coupler. The closed hoop is formed by a base hoop portion, a first side hoop portion, a second side hoop portion, and a top hoop portion. The pier coupler is adjacent to the base hoop portion. The pier coupler includes a first coupler leg, a second coupler leg, and a coupler bridge extending along the base hoop portion between the first coupler leg and the second coupler leg.

### RELATED APPLICATIONS

This application claims the benefit of U.S. Provisional Patent Application No. 63/671,515, filed Jul. 15, 2024, the entire contents of which are incorporated herein by reference.

### TECHNICAL FIELD

This disclosure relates generally to device, system, and method embodiments for solar tracker bearing housings. Certain such embodiments disclosed herein relate to a bearing housing having a closed hoop and a pier coupler for both rotatably supporting a torque tube of a solar tracker and horizontally distributing a load from the bearing housing to an adjacent solar tracker support, such as an adjacent pier that is anchored in the ground.

### BACKGROUND

Solar panels can convert sunlight into energy. As an example, solar photovoltaic panels convert sunlight directly into electricity for a variety of applications. Solar panels are generally composed of an array of solar cells, which are interconnected to each other. The cells are often arranged in series and/or parallel groups of cells in series.

Solar tracker systems can be used to dynamically orient a plurality of solar modules, for instance, by moving the solar modules throughout the course of a given day to track the movement of the sun and thereby increase the efficiency and productivity of the solar modules. Solar tracker systems installed in the field can support the solar modules using a bearing mechanism. However, such typical solar tracker systems can necessitate a significant number of components and inter-component connections and fastening members to ultimately install the solar tracker system at the foundation, and, thus, can increase the cost associated with installing a solar tracker system and/or the cost associated with maintaining operation of a solar tracker system. Moreover, and relatedly, such typical solar tracker system bearing mechanism may not be structurally robust enough to handle certain loads applied at the bearing mechanism during the operational life of the solar tracker.

### SUMMARY

This disclosure in general describes embodiments of devices, systems, and methods relating to solar tracker bearing housings. Certain such embodiments disclosed herein relate to a bearing housing having a closed hoop and a pier coupler for both rotatably supporting a torque tube of a solar tracker and horizontally distributing a load from the bearing housing to an adjacent solar tracker support, such as an adjacent pier that is anchored in the ground. For instance, certain such embodiments disclosed herein include a bearing housing that is configured to: (i) be mounted at the pier to position a torque tube of a solar tracker as hanging, or suspended, below an apex at the bearing housing (e.g., the bearing housing closed hoop is configured to hang the torque tube below an apex at a top hoop portion of the closed hoop), and (ii) transfer a load applied at the bearing housing (e.g., a load applied at the top hoop portion via a pin that is coupled to the torque tube) from a coupler bridge at the bearing housing to the adjacent pier to which the bearing housing is coupled.

Such embodiments disclosed herein can be useful in increasing the load bearing capacity of the bearing housing. For example, as noted, the bearing housing can include a pier coupler having a coupler bridge that extends between first and second coupler legs at the pier coupler. When the bearing housing is mounted to a pier, the bearing housing can be configured to receive a load from a base hoop portion of the closed hoop and to transfer this received load to the coupler bridge at the pier coupler which can then transfer the applied load to the pier. Such a structural configuration of the bearing housing can help to increase a maximum load bearing capacity associated with the bearing housing. Moreover, this structural configuration of the bearing housing can use one or more integrated components to help increase the load bearing capacity while also helping to reduce cost, time, and labor associated with installing a solar tracker system in the field as well as useful in reducing the maintenance cost associated with operating a solar tracker system. For example, bearing housing embodiments disclosed herein can help to reduce the cost of solar tracker installation in the field by reducing a number of components and inter-component connections and fastening members necessary to effectively couple a bearing housing to a support foundation (e.g., a pier) of a solar tracker system. As another example, bearing housing embodiments disclosed herein can be configured to hang, or suspend, a solar tracker system torque tube below an apex of a top hoop portion of the closed hoop of the bearing housing. This bearing housing configuration can lower the elevation of the torque tube and rotational axis of the solar tracker system, which in turn can help to reduce the magnitude of dynamic loads (e.g., wind loads) transferred to the foundation (e.g., pier) which can help to reduce the cost and complexity associated with foundations.

Thus, the bearing housing embodiments disclosed herein can simultaneously provide a number of useful structural advantages which can synergistically help to increase bearing housing load bearing capacity while also helping to reduce cost and complexity associated with solar tracker installation and operational maintenance.

One embodiment includes a solar tracker bearing housing. This solar tracker bearing housing embodiment includes a closed hoop and a pier coupler. The closed hoop is formed by a base hoop portion, a first side hoop portion, a second side hoop portion, and a top hoop portion. The pier coupler is adjacent to the base hoop portion. The pier coupler includes a first coupler leg, a second coupler leg, and a coupler bridge extending along the base hoop portion between the first coupler leg and the second coupler leg.

In a further embodiment of this housing, the first coupler leg extends out from the coupler bridge in a direction away from the base hoop portion, and the second coupler leg extends out from the coupler bridge in a direction away from the base hoop portion. The first coupler leg can be spaced apart from the second coupler leg to define a pier receiving gap therebetween. The coupler bridge can extend a bridge length between the first coupler leg and the second coupler leg, and the bridge length can define the pier receiving gap between the first coupler leg and the second coupler leg. The coupler bridge can extend parallel to the base hoop portion. The first coupler leg can include a first pier mounting aperture, and the second coupler leg can include a second pier mounting aperture. The first coupler leg can extend out from the coupler bridge parallel to the second coupler leg. The first pier mounting aperture can be aligned with the second pier mounting aperture on a pier mounting aperture axis, and the pier mounting aperture axis can extend parallel to both the coupler bridge and the base hoop portion. For example, the first pier mounting aperture can be at a first planar surface at the first coupler leg, and the second pier mounting aperture can be at a second planar surface at the second coupler leg, with the first planar surface being parallel to the second planar surface.

In a further embodiment of this housing, the pier coupler can be a separate component from the closed hoop. For such embodiment, the base hoop portion can include a first inter-component aperture and the coupler bridge can include a second inter-component aperture. The first inter-component aperture, at the base hoop portion, can be aligned with the second inter-component aperture when the pier coupler is coupled to the closed hoop.

In a further embodiment of this housing, the pier coupler can be integral to the closed hoop. For such embodiment, the bearing housing can include a first bearing housing portion and a second bearing housing portion. The first bearing housing portion can include a first portion of each of the closed hoop and the pier coupler, and the second bearing housing portion can include a second portion of each of the closed hoop and the pier coupler such that when the first bearing housing portion is coupled to the second bearing housing portion the first bearing housing portion and the second bearing housing portion form the closed hoop and the pier coupler.

In a further embodiment of this housing, the top hoop portion includes a pin receiving aperture. The pin receiving aperture can sit on an axis that is between the first coupler leg and the second coupler leg and this axis can intersect both the base hoop portion and the coupler bridge.

Another embodiment includes a solar tracker bearing system. This solar tracker bearing system embodiment includes a pier and a bearing housing. The pier includes a first pier end portion that is configured to anchor at a ground surface and a second, opposite pier end portion. The bearing housing includes a closed hoop and a pier coupler. The closed hoop is formed by a base hoop portion, a first side hoop portion, a second side hoop portion, and a top hoop portion. The pier coupler is adjacent to the base hoop portion. The pier coupler includes a first coupler leg configured to couple to the second pier end portion, a second coupler leg configured to couple to the second pier end portion, and a coupler bridge extending along the base hoop portion between the first coupler leg and the second coupler leg. The coupler bridge is configured to sit over the second pier end portion when the first coupler leg and the second coupler leg are coupled to the second pier end portion.

In a further embodiment of this system, the pier includes a C-shaped cross-section. For such embodiment, the first coupler leg can be configured to couple to a first side of the C-shaped cross-section at the second pier end portion, the second coupler leg can be configured to couple to a second, opposite side of the C-shaped cross-section at the second pier end portion, and, when the first coupler leg and the second coupler leg are coupled to the second pier end portion, the coupler bridge can be configured to extend between the first side of the C-shaped cross-section and the second, opposite side of the C-shaped cross-section along the base hoop portion between the first coupler leg and the second coupler leg.

In a further embodiment of this system, the top hoop portion includes a pin receiving aperture. The pin receiving aperture can sit on an axis that is between the first coupler leg and the second coupler leg and that intersects both the base hoop portion and the coupler bridge. For such embodiment, the system can further include a pin. This pin can extend through the pin receiving aperture at the bridge.

In a further embodiment of this system, the first coupler leg extends out from the coupler bridge in a direction away from the base hoop portion, and the second coupler leg extends out from the coupler bridge in a direction away from the base hoop portion. The first coupler leg can be spaced apart from the second coupler leg to define a pier receiving gap therebetween. The coupler bridge can extend a bridge length between the first coupler leg and the second coupler leg, and the bridge length can define the pier receiving gap between the first coupler leg and the second coupler leg.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular examples of the present invention and therefore do not limit the scope of the invention. The drawings are intended for use in conjunction with the explanations in the following detailed description wherein like reference characters denote like elements. Examples of the present invention will hereinafter be described in conjunction with the appended drawings.

FIG. 1 is an elevational view diagram of an embodiment of a solar tracker system.

FIGS. 2A and 2B illustrate one exemplary embodiment of a solar tracker bearing housing. FIG. 2A is a perspective view of the solar tracker bearing housing coupled to a pier, and FIG. 2B is an exploded view of the solar tracker bearing housing of FIG. 2A.

FIGS. 3A and 3B illustrate another exemplary embodiment of a solar tracker bearing housing. FIG. 3A is a perspective view of the solar tracker bearing housing coupled to a pier, and FIG. 3B is an exploded view of the solar tracker bearing housing of FIG. 3A.

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

Embodiments disclosed herein include various devices, systems, and methods relating to relating to solar tracker bearing housings. Certain such embodiments disclosed herein relate to a bearing housing having a closed hoop and a pier coupler for both rotatably supporting a torque tube of a solar tracker and horizontally distributing a load from the bearing housing to an adjacent solar tracker support, such as an adjacent pier that is anchored in the ground.

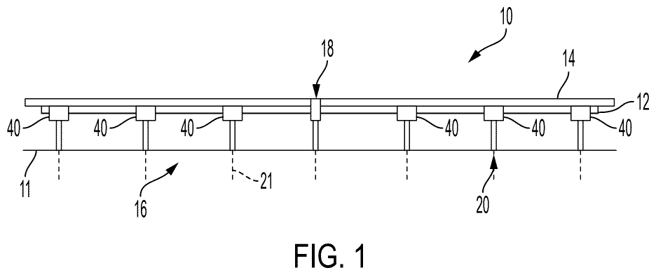

FIG. 1 is an elevational view diagram of a solar tracker system 10. FIG. 1 shows the system 10 at a side elevational view looking in an east-west orientation at the system 10. In some applications, a plurality of solar trackers 10 may be arranged in a north-south longitudinal orientation to form a solar array. The solar tracker system 10 includes a plurality of solar tracker support piers 20 that are disposed in spaced relation to one another and embedded in the earth at ground surface 11. A torque tube 12 extends between each adjacent pier 20 and is rotatably supported at each pier 20. The solar tracker 10 includes a plurality of solar modules, or panels, 14 supported on each respective torque tube 12. The span between two adjacent piers 20 is referred to as a bay 16 and may be generally in the range of about 8 meters in length. Solar tracker support piers 20 can be supported at ground surface 11 via one or more foundation components 21 (e.g., one or more subterranean piles). The foundation components 21 can extend into and below ground surface 11 so as to be embedded into the ground surface 11 to support the above-ground, respective solar tracker support piers 20 and associated respective bearing housings 40. The foundation components 21 can, for example, one or more blade piles (e.g., a pair of blade piles), one or more screw piles (e.g., a pair of screw piles), and/or one or more concrete footings (e.g., a pair of concrete footings) as examples.

The solar tracker 10 includes at least one motive source (e.g., motor, slew drive, etc.) 18 operably coupled to the torque tube 12 and supported on a respective pier 20 of the plurality of piers 20. The motive source 18 effectuates rotation of the torque tube 12, which effectuates a corresponding rotation of the solar panels 14 to track the location of the sun. The solar tracker 10 includes a plurality of bearing housings 40 coupled, respectively, to piers 20. Each of the plurality of bearing housings 40 is operably coupled to the torque tube 12 to rotatably support the torque tube 12 therein as the torque tube 12 is caused to be rotated by the slew drive 18.

Installing a typical solar tracker system in the field can oftentimes necessitate a significant number of interconnections between a significant number of components ranging from subterranean foundation components and connections to above-ground bearing connections and solar module support connections. Moreover, once such components are assembled at installed at the solar tracker system as designed, the load baring capacity of certain such assembled and installed components can be insufficient for the actual operational load borne during operation of the solar tracker system. The solar tracker bearing housing embodiments disclosed herein can be useful in reducing the cost, time, and labor associated with installing a solar tracker system in the field while yet also helping to increase the weight bearing capacity of such bearing housings when used during operation at the solar tracker system. Bearing housing embodiments disclosed herein can be configured to: (i) be mounted at a pier to position a torque tube of a solar tracker as hanging, or suspended, below an apex at the bearing housing (e.g., the bearing housing closed hoop is configured to hang the torque tube below an apex at a top hoop portion of the closed hoop), and (ii) transfer a load applied at the bearing housing (e.g., a load applied at the top hoop portion via a pin that is coupled to the torque tube) from a coupler bridge at the bearing housing to the adjacent pier to which the bearing housing is coupled.

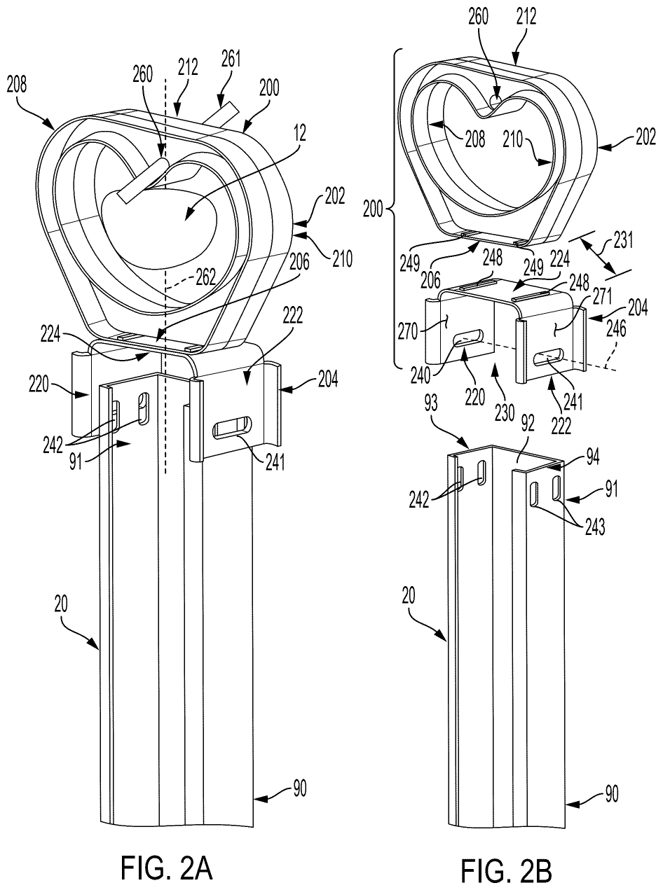

FIGS. 2A-2B illustrate one exemplary embodiment of a solar tracker bearing housing 200. For some applications of the bearing housing 200, the bearing housing 200 can be the bearing housing 40 used in the solar tracker system 10 as illustrated and described in reference to FIG. 1. FIG. 2A is a perspective view of the solar tracker bearing housing 200 coupled to pier 20, and FIG. 2B is an exploded view of the solar tracker bearing housing 200 of FIG. 2A.

The bearing housing 200 can include a closed hoop 202 and a pier coupler 204. The embodiment illustrated at FIGS. 2A and 2B shows the bearing housing 200 as assembled from separate components closed hoop 202 and pier coupler 204. When the closed hoop 202 and the pier coupler 204 are assembled together, the pier coupler 204 can be configured to couple to pier 20 to thereby couple the bearing housing 200 to the pier 20 (e.g., to rotatably support the torque tube 12 at the pier 20 via the bearing housing 200).

The closed hoop 202 can be formed by a base hoop portion 206, a first side hoop portion 208, a second side hoop portion 210, and a top hoop portion 212. The pier coupler 204 can be adjacent to the base hoop portion 206, for instance, when the bearing housing 200 is assembled as shown at FIG. 2A. The pier coupler 204 can include a first coupler leg 220, a second coupler leg 222, and a coupler bridge 224.

The coupler bridge 224 can extend along the base hoop portion 206 between the first coupler leg 220 and the second coupler leg 222, for instance, when the bearing housing 200 is assembled as shown at FIG. 2A. As shown at FIG. 2A, the coupler bridge 224 and/or first and second coupler legs 220, 222 can be configured to couple the bearing housing 200 to the pier 20. For example, the pier 20 can include a first pier end portion 90, which is configured to anchor at ground surface 11, and a second pier end portion 91, which is opposite the first pier end portion 90. Again referring to FIG. 2A, the coupler bridge 224 can be configured to sit over second pier end portion 91 when the first coupler leg 220 and the second coupler leg 222 are coupled to the second pier end portion 91. Thus, in some such applications, the coupler bridge 224 can provide a type of cap that extends over an end of the pier 20 opposite the ground surface 11.

In some exemplary applications, the pier 200 can include a C-shaped cross-section 92. For such exemplary applications, the first coupler leg 220 can be configured to couple to a first side 93 of the C-shaped cross-section 92 at the second pier end portion 91, and the second coupler leg 222 can be configured to couple to a second, opposite side 94 of the C-shaped cross-section 92 at the second pier end portion 91. Then, for such exemplary applications (e.g., where the pier 20 includes the C-shaped cross-section 92), the coupler bridge 224 can be configured to extend between the first side 93 of the C-shaped cross-section 92 and the second, opposite side 94 of the C-shaped cross-section 92 along the base hoop portion 206 between the first coupler leg 220 and the second coupler leg 222 when the first coupler leg 220 and the second coupler leg 222 are coupled to the second pier end portion 91. In this way, the bearing housing 200 can couple to the second pier end portion 91 and support (e.g., rotatably support) thereat the torque tube 12.

When the closed hoop 202 and the pier coupler 204 are assembled together, the first coupler leg 220 can extend out from the coupler bridge 224 in a direction away from the base hoop portion 206, and the second coupler leg 222 can extend out from the coupler bridge 224 in a direction away from the base hoop portion 206. The first coupler leg 220 can be spaced apart from the second coupler leg 222 to define a pier receiving gap 230 therebetween. The coupler bridge 224 can extend a bridge length 231 between the first coupler leg 220 and the second coupler leg 222. The bridge length 231 can define the pier receiving gap 230 between the first coupler leg 220 and the second coupler leg 222. The coupler bridge 224 can extend parallel to the base hoop portion 206. For instance, referring to FIG. 2A, the coupler bridge 224 can extend the bridge length 231 between the first coupler leg 220 and the second coupler leg 222 parallel to the base hoop portion 206 when the closed hoop 202 and the pier coupler 204 are assembled together.

As noted, the coupler bridge 224 along with the first and second coupler legs 220, 222 can be configured to couple the bearing housing 200 to the pier 20. For some applications, the illustrated example shows that the first coupler leg 220 can include a first pier mounting aperture 240, and the second coupler leg 222 can include a second pier mounting aperture 241. The second pier end portion 91 can include complementary first and second mounting apertures 242, 243. To couple the bearing housing 200 to the second pier end portion 91, the first coupler leg 220 can be placed adjacent to the first mounting apertures 242 at the first side 93 of the second pier end portion 91 such that the first pier mounting aperture 240 is aligned with the first mounting apertures 242 at the second pier end portion 91, and, likewise, the second coupler leg 222 can be placed adjacent to the second mounting apertures 243 at the second side 94 at the second pier end portion 91 such that the second pier mounting aperture 241 is aligned with the second mounting apertures 243 at the second pier end portion 91. When the pier coupler 204 is so positioned relative to the second pier end portion 91, the first coupler leg 220 can extend out from the coupler bridge 224 parallel to the second coupler leg 222. And when the pier coupler 204 is so positioned relative to the second pier end portion 91, the first pier mounting aperture 240 can be aligned with the second pier mounting aperture 241 on a pier mounting aperture axis 246. For instance, the pier mounting aperture axis 246 can extend parallel to both the coupler bridge 224 and the base hoop portion 206. The illustrated embodiment shows that the first pier mounting aperture 240 can be at a first planar surface 270 at the first coupler leg 220, and the second pier mounting aperture 241 can be at a second planar surface 271 at the second coupler leg 222. For the illustrated embodiment, the first planar surface 270 is parallel to the second planar surface 271.

As noted, the embodiment of the bearing housing 200 shown at the example of FIGS. 2A and 2B includes the closed hoop 202 and the pier coupler 204 as separate components from one another. For such embodiment of the bearing housing 200, the base hoop portion 206 can include at least one first inter-component aperture 249 and the coupler bridge 224 can include at least one second inter-component aperture 248. In some examples, to couple the bearing housing 200 to the second pier end portion 91, one or more fasteners can be placed at aligned first inter-component aperture 249 and second inter-component aperture 248. Thus, the first inter-component aperture 249 at the base hoop portion 206 can be aligned with the second inter-component aperture 248 when the pier coupler 204 is coupled to the closed hoop 202.

The illustrated embodiment of the bearing housing 200 can further include a pin receiving aperture 260. As illustrated at FIGS. 2A and 2B, the pin receiving aperture 260 can be at the top hoop portion 212. The pin receiving aperture 260 can sit on an axis 262 that is between the first coupler leg 220 and the second coupler leg 222 and that intersects both the base hoop portion 206 and the coupler bridge 224. In some embodiments, the bearing housing 200 can further include a pin 261. When included, the pin 261 can extend through the pin receiving aperture 260 at the top hoop portion 212. The pin 261 can be configured to rotatably couple to the torque tube 12 such that the pin 261 can suspend, or hang, the torque tube 12 below an apex, or greatest elevation surface above the ground surface 11, at the top hoop portion 212. Thus, as shown for the example at FIG. 2A, the pin 261 can extend through the pin receiving aperture 260 at the top hoop portion 212 so as to rotatably suspend the torque tube 12 between the coupler bridge 224 and the top hoop portion 212. In this way, the torque tube 12 can rotate relative to the bearing housing 200 via the pin 261.

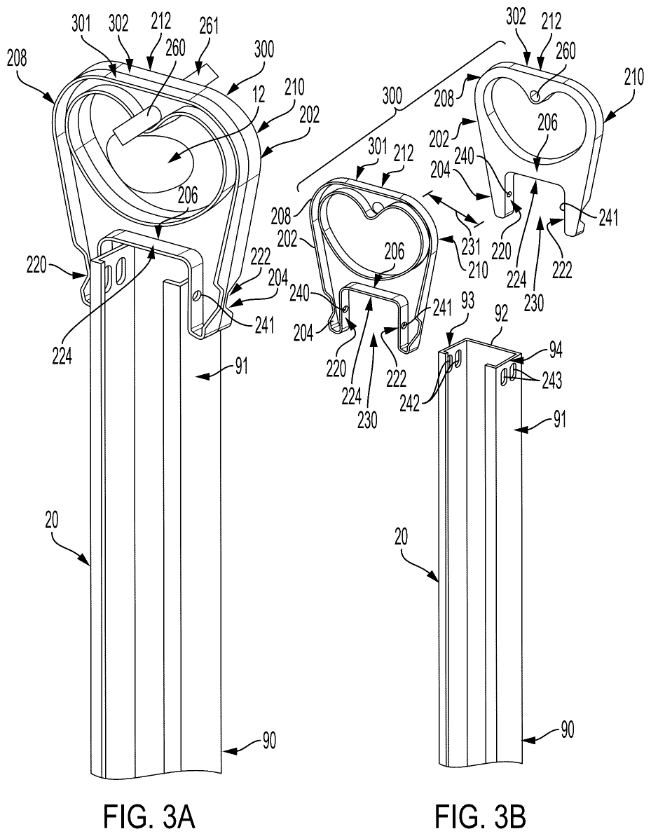

FIGS. 3A and 3B illustrate another exemplary embodiment of a solar tracker bearing housing 300. FIG. 3A is a perspective view of the solar tracker bearing housing 300 coupled to pier 20, and FIG. 3B is an exploded view of the solar tracker bearing housing 300. For some applications of the bearing housing 300, the bearing housing 300 can be the bearing housing 40 used in the solar tracker system 10 as illustrated and described in reference to FIG. 1. Some such applications can include the bearing housing 300 with one or more (e.g., each) of the elements disclosed previously herein with respect to the bearing housing 200 and, as such, like reference characters denote like elements. As will be described further below, for some embodiments, the bearing housing 300 can be similar to, or the same as, the bearing housing 200 except that the bearing housing 300 includes the pier coupler 204 as integral to the closed hoop 202 and the bearing housing 300 forms the closed hoop 202 using separate bearing housing components, assembled together, to form the closed hoop 202.

The bearing housing 300 can include closed hoop 202 and pier coupler 204. As noted, the embodiment illustrated at FIGS. 3A and 3B shows the bearing housing 300 having the pier coupler 204 as integral to the closed hoop 202 and shows the bearing housing 300 forming the closed hoop 202 from separate components. Namely, the embodiment of the bearing housing 300 shown here can include a first bearing housing portion 301 and a second bearing housing portion 302. The first bearing housing portion 301 can include a first portion of each of the closed hoop 202 and the pier coupler 204, and the second bearing housing portion 302 can include a second portion of each of the closed hoop 202 and the pier coupler 204 such that, when the first bearing housing portion 301 is coupled to the second bearing housing portion 302, the first bearing housing portion 301 and the second bearing housing portion 302 can form the closed hoop 202 and the pier coupler 204. And when the closed hoop 202 and the pier coupler 204 are formed by assembling together the first and second bearing housing portions 301, 302, the pier coupler 204 can be configured to couple to pier 20 to thereby couple the bearing housing 300 to the pier 20 (e.g., to rotatably support the torque tube 12 at the pier 20 via the bearing housing 300).

In particular, the closed hoop 202 can be formed by: (i) a first portion of each of the base hoop portion 206, the first side hoop portion 208, the second side hoop portion 210, and the top hoop portion 212 at the first bearing housing portion 301, and (ii) a second portion of each of the base hoop portion 206, the first side hoop portion 208, the second side hoop portion 210, and the top hoop portion 212 at the second bearing housing portion 302. And, similarly, the pier coupler 204 can be formed by: (i) a first portion of each of the first coupler leg 220, the second coupler leg 222, and the coupler bridge 224 at the first bearing housing portion 301, and (ii) a second portion of each of the first coupler leg 220, the second coupler leg 222, and the coupler bridge 224 at the second bearing housing portion 302. The first bearing housing portion 301 and the second bearing housing portion 302 can be assembled together as shown at the example of FIG. 3B to form the bearing housing 300 as shown at the example of FIG. 3A. Any of a variety of mechanical couplings (e.g., toxing) can be used between the first and second bearing housing portions 301, 302.

When the first bearing housing portion 301 and the second bearing housing portion 302 can be assembled together according to the example embodiment at FIGS. 3A and 3B, the pier coupler 204 can be adjacent to the base hoop portion 206, and the coupler bridge 224 can extend along the base hoop portion 206 between the first coupler leg 220 and the second coupler leg 222. As shown at FIG. 3A, the coupler bridge 224 and first and second coupler legs 220, 222 can be configured to couple the bearing housing 300 to the pier 20, for example, at the second pier end portion 91 with the coupler bridge 224 configured to sit over second pier end portion 91 when the first coupler leg 220 and the second coupler leg 222 are coupled to the second pier end portion 91. Thus, as shown at the example at FIG. 3A, in some such applications, the coupler bridge 224 can provide a type of cap that extends over an end of the pier 20 opposite the ground surface 11.

When the first bearing housing portion 301 and the second bearing housing portion 302 are assembled together to form the closed hoop 202 and the pier coupler 204, the first coupler leg 220 can extend out from the coupler bridge 224 in a direction away from the base hoop portion 206, and the second coupler leg 222 can extend out from the coupler bridge 224 in a direction away from the base hoop portion 206. The first coupler leg 220 can be spaced apart from the second coupler leg 222 to define pier receiving gap 230 therebetween. The coupler bridge 224 can extend the bridge length 231 between the first coupler leg 220 and the second coupler leg 222, and the bridge length 231 can define the pier receiving gap 230 between the first coupler leg 220 and the second coupler leg 222. The coupler bridge 224 can extend parallel to the base hoop portion 206. For instance, referring to FIG. 3A, the coupler bridge 224 can extend the bridge length 231 between the first coupler leg 220 and the second coupler leg 222 parallel to the base hoop portion 206 when the first bearing housing portion 301 and the second bearing housing portion 302 are assembled together.

As with the bearing housing 200, the bearing housing 300 illustrated at FIGS. 3A and 3B can be configured to couple the bearing housing 300 to the pier 20 at the first and second coupler legs 220, 222 (e.g., using the respective first pier mounting aperture 240 and the second pier mounting aperture 241). To couple the bearing housing 300 to the second pier end portion 91, the first coupler leg 220 can be coupled to the first mounting aperture 242 at the second pier end portion 91 via the first pier mounting aperture 240 at the first coupler leg 220 and the second coupler leg 222 can be coupled to the second mounting aperture 243 at the second pier end portion 91 via the second pier mounting aperture 241 at the second coupler leg 222.

The illustrated embodiment of the bearing housing 300 at FIG. 3A, like that illustrated for the bearing housing 200 at FIG. 2A, can further include the pin receiving aperture 260, for instance, at the top hoop portion 212. And, in some embodiments, the bearing housing 300 can further include pin 261. When included, the pin 261 can extend through the pin receiving aperture 260 at the top hoop portion 212. The pin 261 can be configured to rotatably couple to the torque tube 12 such that the pin 261 can suspend, or hang, the torque tube 12 below an apex, or greatest elevation surface above the ground surface 11, at the top hoop portion 212. Thus, as shown for the example at FIG. 3A, the pin 261 can extend through the pin receiving aperture 260 at the top hoop portion 212 so as to rotatably suspend the torque tube 12 between the coupler bridge 224 and the top hoop portion 212. In this way, the torque tube 12 can rotate relative to the bearing housing 300 via the pin 261.

Various examples have been described. These and other examples are within the scope of the following claims.

What is claimed is:

1. A solar tracker bearing housing comprising:
a closed hoop formed by a base hoop portion, a first side hoop portion, a second side hoop portion, and a top hoop portion; and
a pier coupler adjacent to the base hoop portion, the pier coupler comprising a first coupler leg, a second coupler leg, and a coupler bridge extending along the base hoop portion between the first coupler leg and the second coupler leg.

2. The housing of claim 1, wherein the first coupler leg extends out from the coupler bridge in a direction away from the base hoop portion, and wherein the second coupler leg extends out from the coupler bridge in a direction away from the base hoop portion.

3. The housing of claim 2, wherein the first coupler leg is spaced apart from the second coupler leg to define a pier receiving gap therebetween.

4. The housing of claim 3, wherein the coupler bridge extends a bridge length between the first coupler leg and the second coupler leg, and wherein the bridge length defines the pier receiving gap between the first coupler leg and the second coupler leg.

5. The housing of claim 4, wherein the coupler bridge extends parallel to the base hoop portion.

6. The housing of claim 3, wherein the first coupler leg comprises a first pier mounting aperture, and wherein the second coupler leg comprises a second pier mounting aperture.

7. The housing of claim 6, wherein the first coupler leg extends out from the coupler bridge parallel to the second coupler leg.

8. The housing of claim 7, wherein the first pier mounting aperture is aligned with the second pier mounting aperture on a pier mounting aperture axis, and wherein the pier mounting aperture axis extends parallel to both the coupler bridge and the base hoop portion.

9. The housing of claim 8, wherein the first pier mounting aperture is at a first planar surface at the first coupler leg, wherein the second pier mounting aperture is at a second planar surface at the second coupler leg, and wherein the first planar surface is parallel to the second planar surface.

10. The housing of claim 1, wherein the pier coupler is a separate component from the closed hoop, wherein the base hoop portion comprises a first inter-component aperture, wherein the coupler bridge comprises a second inter-component aperture, and wherein the first inter-component aperture at the base hoop portion is aligned with the second inter-component aperture when the pier coupler is coupled to the closed hoop.

11. The housing of claim 1, wherein the pier coupler is integral to the closed hoop.

12. The housing of claim 11, wherein the bearing housing comprises a first bearing housing portion and a second bearing housing portion, wherein the first bearing housing portion comprises a first portion of each of the closed hoop and the pier coupler, and wherein the second bearing housing portion comprises a second portion of each of the closed hoop and the pier coupler such that when the first bearing housing portion is coupled to the second bearing housing portion the first bearing housing portion and the second bearing housing portion form the closed hoop and the pier coupler.

13. The housing of claim 1, wherein the top hoop portion comprises a pin receiving aperture, and wherein the pin receiving aperture sits on an axis that is between the first coupler leg and the second coupler leg and that intersects both the base hoop portion and the coupler bridge.

14. A solar tracker bearing system comprising:
a pier comprising a first pier end portion that is configured to anchor at a ground surface and a second, opposite pier end portion; and
a bearing housing comprising:
a closed hoop formed by a base hoop portion, a first side hoop portion, a second side hoop portion, and a top hoop portion; and
a pier coupler adjacent to the base hoop portion, the pier coupler comprising a first coupler leg configured to couple to the second pier end portion, a second coupler leg configured to couple to the second pier end portion, and a coupler bridge extending along the base hoop portion between the first coupler leg and the second coupler leg, the coupler bridge configured to sit over the second pier end portion when the first coupler leg and the second coupler leg are coupled to the second pier end portion.

15. The system of claim 14, wherein the pier comprises a C-shaped cross-section.

16. The system of claim 15,
wherein the first coupler leg is configured to couple to a first side of the C-shaped cross-section at the second pier end portion,
wherein the second coupler leg is configured to couple to a second, opposite side of the C-shaped cross-section at the second pier end portion, and
wherein the coupler bridge is configured to extend between the first side of the C-shaped cross-section and the second, opposite side of the C-shaped cross-section along the base hoop portion between the first coupler leg and the second coupler leg when the first coupler leg and the second coupler leg are coupled to the second pier end portion.

17. The system of claim 14, wherein the top hoop portion comprises a pin receiving aperture, and wherein the pin receiving aperture sits on an axis that is between the first coupler leg and the second coupler leg and that intersects both the base hoop portion and the coupler bridge.

18. The system of claim 17, further comprising: a pin extending through the pin receiving aperture at the coupler bridge.

19. The system of claim 14, wherein the first coupler leg extends out from the coupler bridge in a direction away from the base hoop portion, and wherein the second coupler leg extends out from the coupler bridge in a direction away from the base hoop portion.

20. The system of claim 19, wherein the first coupler leg is spaced apart from the second coupler leg to define a pier receiving gap therebetween, wherein the coupler bridge extends a bridge length between the first coupler leg and the second coupler leg, and wherein the bridge length defines the pier receiving gap between the first coupler leg and the second coupler leg.
